(19) United States
(12) Patent Application Publication
(10) Pub. No.: US 2018/0101939 A1
(43) Pub. Date: Apr. 12, 2018

(54) CONTROL ARRANGEMENTS FOR DIGITAL IMAGE COLOR ENHANCEMENT

(71) Applicant: Microsoft Technology Licensing, LLC, Redmond, WA (US)

(72) Inventor: Tobias Priemer, Bara (SE)

(21) Appl. No.: 15/289,109

(22) Filed: Oct. 7, 2016

(51) Int. Cl. G06T 5/00; G06F 3/0484

(52) U.S. Cl. CPC G06T 5/009; G06F 3/04845; G06F 3/04883; G06T 2207/20092; G06T 2207/10024

(57) ABSTRACT

An apparatus comprises a display, and a processing unit which is configured to obtain initial image data of an initial digital image frame; control the display to show an initial digital image in accordance with the initial image data, and a single graphical user input tool allowing a user of the apparatus to input, via the single graphical user input tool, a color enhancement command for enhancing a selected color in the initial digital image, the color enhancement command defining selection between color enhancement effects of increasing colorfulness of the selected color and decreasing colorfulness of color(s) differing from the selected color, and degree of the selected color enhancement effect; obtain a color enhancement command input by the user via the single graphical user input tool; and produce enhanced image data enhanced, for the selected color, in accordance with the obtained color enhancement command.

### BACKGROUND

An image editing application executed on an apparatus may allow user of the apparatus to enhance specific color(s) of a digital image displayed on a display by inputting one or more color enhancement commands to the apparatus. Enhancing some specific color(s) may be carried out, in accordance with a color enhancement command input by the user via a user interface, by increasing the colorfulness of the desired color(s), referred to as “color boost”, or by decreasing the colorfulness of other color(s) of the digital image, referred to as “color pop”.

The implementation of the user interface may affect, for example, the usability of the image editing application as well as the complexity of the system configured to produce the user interface.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An apparatus is disclosed which may comprise a display, and a processing unit configured to obtain initial image data of an initial digital image frame; and to control the display to show thereon an initial digital image formed in accordance with the initial image data, and a single graphical user input tool allowing a user of the apparatus to input, via the single graphical user input tool, a color enhancement command for enhancing a selected color in the initial digital image, the color enhancement command defining selection between color enhancement effects of increasing colorfulness of the selected color and decreasing colorfulness of color(s) different from the selected color, and degree of the selected color enhancement effect.

The apparatus may further be configured to obtain a color enhancement command input by the user via the single graphical user input tool; and produce enhanced image data enhanced, in comparison to the initial image data, for the selected color, in accordance with the obtained color enhancement command.

### DESCRIPTION OF THE DRAWINGS

The present description will be better understood from the following detailed description read in light of the accompanying drawings, wherein:

FIG. 1 shows a schematic drawing of an apparatus capable of applying color enhancement in digital images;

FIG. 2 illustrates the apparatus of FIG. 1 in a different stage of its operation;

FIGS. 3 to 5 illustrate schematically different types of apparatuses capable of applying color enhancement in digital images; and

FIG. 6 illustrates a flow chart of a method for applying color enhancement in digital images.

### DETAILED DESCRIPTION

The detailed description provided below in connection with the appended drawings is intended as a description of a number of embodiments and is not intended to represent the only forms in which the embodiments may be constructed, implemented, or utilized.

At least some of the embodiments and examples discussed below may allow, for example, implementing a graphical user interface for an image editing application or an image editing apparatus, requiring limited area of a display only, thereby leaving a large portion of the display free to display the actual digital image to be edited thereon. Further, at least some of the embodiments and examples discussed below may allow, for example, implementing such graphical user interface which may be produced using relatively simple system and program code. Further, at least some of the embodiments and examples discussed below may allow implementing a graphical user interface for an image editing application, which is simple to use by a user.

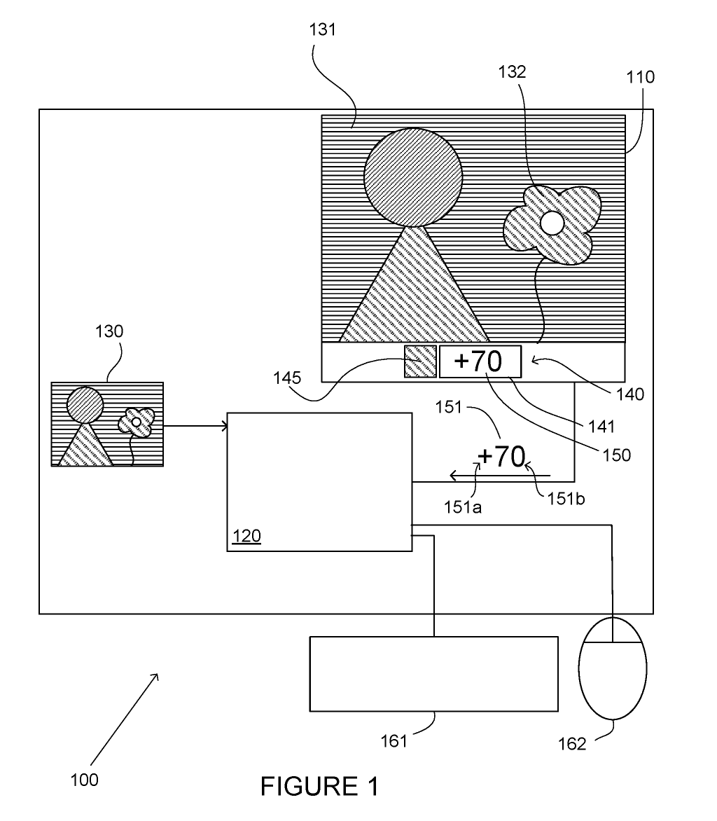

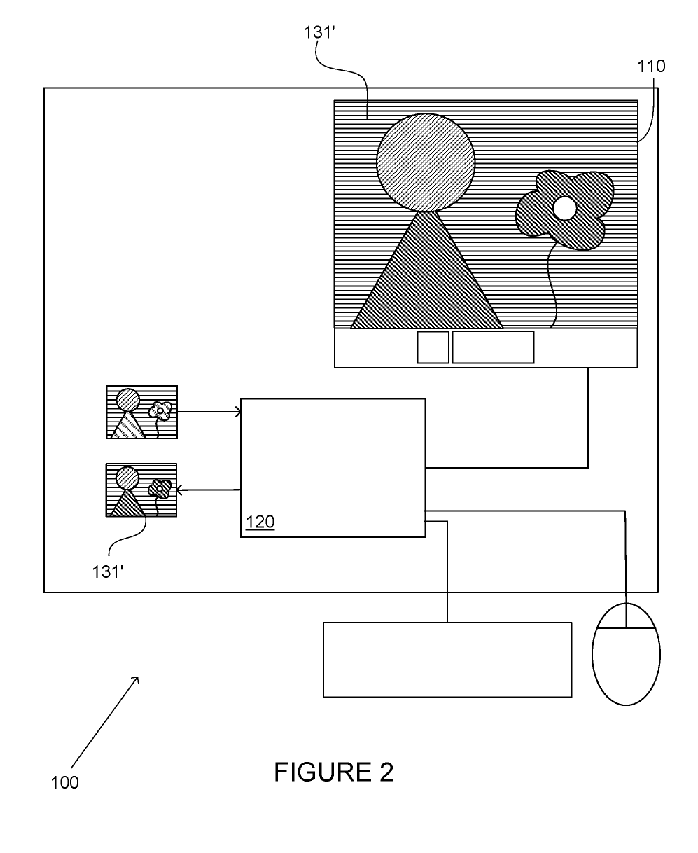

Generally, an apparatus in accordance with any of those discussed below with reference to FIGS. 1 and 2 may be implemented, for example, as a personal computer, a laptop computer, a tablet computer, a smart phone, a mobile phone, a game console, a wearable device, or a digital image viewing apparatus.

The apparatus 100 comprises a display 110 which may be any appropriate type of electronic display, such as a light emitting diode (LED) display, organic light emitting diode (OLED) display, active-matrix organic light-emitting diode (AMOLED) display, thin-film transistor (TFT) display, liquid crystal displays (LCD), without being limited to these examples.

The apparatus 100 further comprises a processing unit 120 communicably coupled to the display 110.

The processing unit is configured to obtain initial image data of an initial digital image frame 130.

A “digital image frame”, or shortly a “frame”, refers to a data content captured via exposure of pixels or some other light-sensing element(s) of an image sensor. A frame thus comprises image data enabling composition of a displayable digital image on the basis of, and in accordance with, that image data. Image data of a digital image frame may comprise, for example, information about light energy received by pixels of an image sensor. A frame may be captured as a frame for a still image or as one frame of a video sequence or some other frame sequence or group of frames.

“Obtaining” image data of a digital image frame or any other appropriate data content refers basically to any appropriate way of providing available, for automatic data processing and/or storage purposes, such data content. For example, such data content or a part of such may be obtained via any appropriate wired or wireless data transmission path from another device or apparatus or another unit of the same apparatus, from an external data server or, for example, from a cloud service. Such data content may also be stored in or on any appropriate data storage unit, element, medium, or device, from which the processing unit may obtain the data content.

In some embodiments, obtaining initial image data may also comprise generating such data. This may be the case, for example, when the apparatus comprises an image sensor forming a part of a digital camera, capable of capturing digital image frames. Such digital camera may be implemented, for example, as a digital camera module incorporated in a mobile or portable device such as a mobile phone, a laptop computer, or a tablet computer.

The processing unit 120 is further configured to control the display 110 to show thereon an initial digital image 131 in accordance with the initial image data, and a single graphical user input tool 140 allowing a user of the apparatus to input, via the single graphical user input tool, one or more color enhancement commands 151 defining selection between color enhancement effects of increasing colorfulness of a selected color and decreasing colorfulness of color(s) different from the selected color, and degree of the selected color enhancement effect.

“Show” refers to presenting, or displaying, information content on the display in visually observable form.

“Graphical user input tool” refers to any appropriate type of graphically presented object, capable of guiding a user of the apparatus to appropriately input one or more color enhancement commands to the apparatus.

The single graphical user input tool shown on the display, allowing the user to input color enhancement command, may be considered to form a part of a graphical user interface of the apparatus or an application run on it.

Basically, actual inputting of the color enhancement command may be effected by using any appropriate input or control equipment connected to the apparatus and the processing unit thereof. Examples of such input or control equipment comprise, not being limited to, a keyboard, a mouse, a joystick, a keypad, a touch pad, a touch screen with a touch sensor integrated to the display, soft keys, a microphone, and the like. Input or control equipment of the example apparatus of FIG. 1 are discussed below.

The input or control equipment, as well as the display controlled to show the initial digital image and the single graphical user input tool may be considered as parts of a complete user interface of the apparatus.

“Color enhancement” refers to producing an enhanced, altered digital image or digital image frame or digital image thereof where the selected color is enhanced, i.e. emphasized relative to the other colors.

Color enhancement of a specific color may be produced in a digital image by changing the “colorfulness”, i.e. the intensity of that color or other color(s) in the image. This may be carried out by increasing the colorfulness or color intensity of the selected color, referred to as “color boost”, or by decreasing the colorfulness of the other color(s), which is referred to as “color pop”. For example, in the case of red as the selected color and color boost as the selected color enhancement effect, in those parts of the initial digital image where the image color is red, the colorfulness may be increased, thereby making those areas “more red”, whereas the other areas may be left unchanged. In the case of color pop, the originally red areas may be left unchanged, and the colorfulness of all other colors may be decreased, thereby lowering the color intensity, i.e. the “colorfulness” thereof.

In determining and adjusting the colorfulness, of color(s) in a digital image, for example, saturation can be used as the measure of the colorfulness. Then, increasing or decreasing the colorfulness of a color may refer to increasing or decreasing, respectively, the saturation of that color.

Those different areas may be defined on a pixel basis, i.e. it may be determined pixel-by-pixel, by comparing the color of each pixel to the selected color, where to apply the color enhancement effect. In such comparison, a tolerance may be used to determine that actual image colors slightly deviating, within the tolerance, from the exact selected color, are classified to belong to the selected color to be enhanced.

The “colors” may be defined and enhanced in accordance with any appropriate color model or system. For example, image colors originally produced in accordance with the RBG (Red-Green-Blue) model or system, using red, green, and blue, may be converted or transformed for the color enhancement operation to HSL (Hue, Saturation, and Lightness/Luminosity) or HSV/B (Hue, Space, and Value/Brightness) space or system where each RGB color is represented as a combination of hue, saturation, and lightness/luminosity/brightness, the hue representing the actual “color” and saturation the “colorfulness” of that color. When carrying out the color enhancement effect operation in HSL or HSV space, the tolerance mentioned above may refer, for example, to allowed deviation from the exact hue value of the selected color. The color enhancement may be carried out by adjusting the hue value of each pixel where the color enhancement is to be applied. Thereafter, the HSL or HSV parameters of the pixels may be converted back to the RGB space.

The “color enhancement command” refers to a request to the apparatus to carry out a color enhancement effect for enhancing the selected color in the initial digital image, thereby producing an enhanced digital image. Defining the selection between color boost and color pop refers to defining whether the request concerns applying color boost or color pop. Defining the degree of the selected color enhancement effect refers to defining how strong effect is requested to be carried out, i.e. to what extent the selected effect is to be carried out. For example, in the case of color pop, maximum degree may result in completely fading out colors other than the selected one(s), thereby converting those initial colors to different shades of grey.

Showing on the display a single graphical user input tool allowing the user to input via it both the selection between color boost and color pop, and the degree of the color enhancement effect may provide advantages e.g. in that in comparison to different user input tools for color boost and color pop, smaller portion of the display's operable area is needed for the interactive graphical user interface, whereby a greater portion thereof may be used for displaying the actual digital image. Further, it may be more straightforward to control the display to display one single input tool instead of two separate ones. From the user point of view, one single input tool may provide easy and convenient way to control the color enhancement operations.

In the example of FIG. 1, the processing unit 120 is configured to control the display 110 to show the single graphical user input tool as comprising a text input field 141, via which the user may input the color enhancement command(s) as text 150.

“Text” forming, at least partially, a color enhancement command refers to any combination of any types of letters, numbers, and/or special graphic symbols of any alphabetic, numeral, and symbol systems. In the example of FIG. 1, the text 150 forming the color enhancement command 151 “+70” comprises a “+” character as a sign indicating “positive” numerical value, and number “70”, formed by Arabic numerals “7” and “0”, indicating specific numerical value in the positive numerical value range. In other embodiments, color enhancement commands as text may be input using any other appropriate alphabetic or numeral or symbolic systems, such as Chinese, Arabic, Cyrillic, Greek, or Japanese letters.

The apparatus of FIG. 1 is an example where the colorfulness, measured as saturation, of a specific color always lies between limit values of 0 and 100%, the latter representing the “full” colorfulness, whereas saturation of 0% refers actually the color converted to grey.

“Limit value” refers to an end value, e.g. highest or lowest possible value, of a parameter, such as the percentage value of the colorfulness.

In the example of FIG. 1, the apparatus comprises a keypad 161 and a mouse 162 as control or input equipment connected to the processing unit. The keypad and the mouse belong, together with the display, to the overall user interface of the apparatus. The user may input the color enhancement command, for example, by using the mouse to point and select the single graphical user input tool 140, and writing then the color enhancement command by using the keypad.

An apparatus as that illustrated in FIG. 1, comprising a keypad and a mouse, may be, for example, a personal computer or a laptop computer. In the case of a laptop computer, the keypad and the mouse may be integrated, differently from the schematic drawing of FIG. 1, to the same device body with the processor. In other embodiments, apparatuses comprising, for example, a touch screen as input or control equipment, may be implemented as a mobile electronic device, such a mobile phone, smart phone, a tablet computer, or as an apparatus specifically designed for viewing and/or editing digital images.

In the example of FIG. 1, the user may input the color enhancement command as a single input element, such as the example single input element 151 “+70” illustrated in the drawing. In this example, the single input element 151 is an example of a two-part input element construction comprising a selection part 151a, such as the sign “+” in the example of FIG. 1, and a degree determination part 151b, such as the numeric value “70” in the example of FIG. 1.

In other embodiments, other types of single input elements may be used, defining the selection between color boost and color pop via some other appropriate way than by two-part construction of the single input element.

In yet other embodiments, the user may input the color enhancement command as several input elements. For example, one input element may be used to define selection between color boost and color pop, and another input element for defining degree of the selected color enhancement effect. For example, a first input element may comprise text such as “boost” or “pop”, and a second element some numeric value, such as “70” or any other appropriate number.

A single graphical user input tool allowing inputting the color enhancement command as one single input element may provide advantages, for example, in simpler configuration and/or faster operation of the graphical user interface, a part which the single graphical user input tool forms, in comparison to user input tools necessitating inputting the color enhancement commands sequentially as two or more input elements.

In the example of FIG. 1, the processing unit 120 is configured to show the text written by the user using the keyboard in the text input field 141. The user may complete the inputting operation by accepting the written text as the color enhancement command, for example, by pressing “enter” in the keyboard, or by any other appropriate way. The processing unit 120 is configured to then obtain the color enhancement command 151.

The processing unit 120 of the example of FIG. 1 is also configured to control the display 110 to show thereon, as part of the graphical user interface, a color indicator 145 indicating the selected color to be enhanced. In the example of FIG. 1, this selected color is that present, for example, in the flower 132 of the initial digital image 131.

Further, the processing unit is configured to produce enhanced image data which is enhanced, in comparison to the initial image data, for the selected color, in accordance with the obtained color enhancement command.

For producing the enhanced image data, the processing unit 120 is configured to determine selection between color boost and color pop in accordance with the selection part 151a of the single input element, namely, the sign “+”, and degree of the selected color′ enhancement effect in accordance with the degree determination part 151b or the single input element 151, namely, the numerical value “70”. In the example of FIG. 1, the processing unit thus produces image data where the selected color is enhanced by color boost effect, by setting the selected color or hue, and similar color or hues within a tolerance determined automatically or by the user beforehand, by setting the saturation thereof up to 70% of the maximum increment available. For those pixels with the selected color, or a color within an allowed tolerance from the selected color, already having saturation at 70% or higher, no adjustment is made.

As discussed above, the operation of producing enhanced image data may comprise first determining, for each pixel of the digital image, whether it has a color sufficiently similar to the selected color, i.e. within the predetermined tolerance. Thereby, the processing unit may divide the pixels into two groups, one for which the required color enhancement is to be applied, and another to be left without color enhancement.

The processing unit may produce the enhanced image data by adjusting the initial image data of the initial digital image frame. Alternatively, it may generate a new enhanced digital image frame. The latter option allows storing both the initial and the enhanced image data at least until the user finalizes the color enhancing operation(s). It may also allow the user to return to the initial image data and start the color enhancing operation(s) again from the beginning.

As illustrated in FIG. 2, the processing unit 120 of the apparatus 100 is further configured to control the display 110 to show thereon an enhanced digital image 131′ formed in accordance with the enhanced image data. On the basis of the enhanced digital image, the user may observe the result of the requested color enhancement, and input a further color enhancement command, with the already enhanced image data as new “initial” image data. Alternatively, the user may input, in any appropriate way by any appropriate equipment, a finalizing command to finalize the color enhancement operation(s) whereby the processing unit may store and/or transmit an enhanced digital image frame 130′.

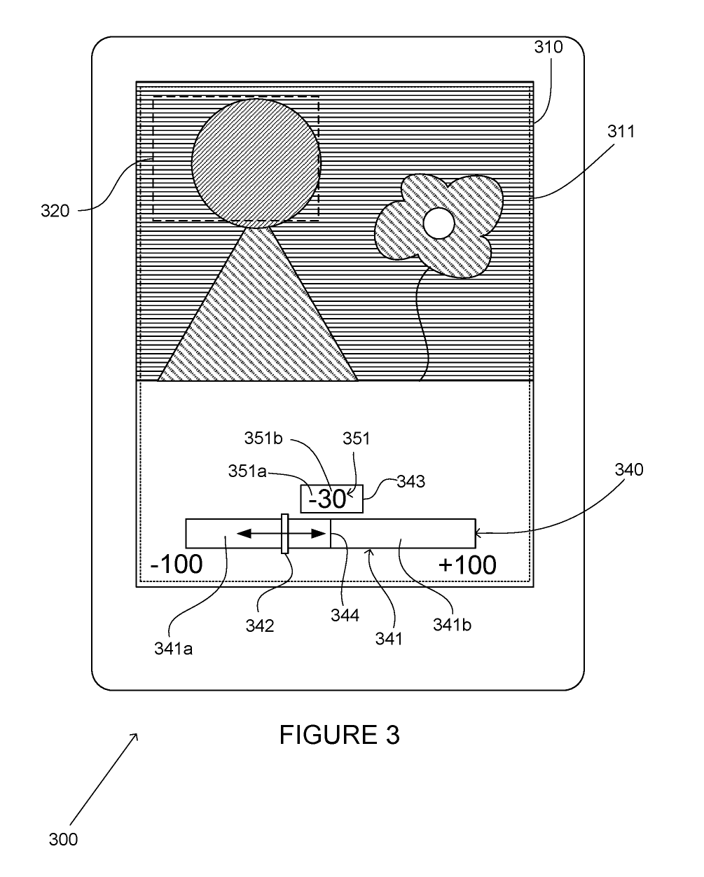

The apparatus 300 of FIG. 3 differs from that of FIGS. 1 and 2, for example, in that it is implemented as a mobile electronic device having a touch screen with a touch sensitive panel 311 integrated together with the display 310 of the apparatus. Thereby, the user of the apparatus may control the apparatus by touching the touch screen.

The apparatus 300 of FIG. 3 differs from that of FIGS. 1 and 2 also at least in that instead of a text input field, the single graphical user input tool 340, shown on the display as controlled by the processing unit 320, comprises an input field in the form of scale 341, illustrated as a bar, representing numerical values from −100 to +100. The negative portion 341a of the scale represents a first input field area, whereas the positive 341b portion thereof represents a second input field area of the input field. The single graphical user input tool further comprises a slider 342 as a sliding pointer which is slidable by the user along the scale 341.

By the slider, the user may select a specific position within the scale. Thereby, the user is allowed to input the single input element by selecting a position on the scale, i.e. within the input field, the selection representing in the example of FIG. 3 a specific numeric value between the limit values −100 and +100.

In the example illustrated in FIG. 3, the slider 342 lies at a location representing value “−30” representing the single input element 351 as the color enhancement command. The processing unit 320 is configured to control the display to show this selection in a selection field 343 as part of the graphical user interface.

Inputting the color enhancement command by the slider 342 constitutes an example of defining the selection part 351a of the single input element, namely, the sign “−” in the example of FIG. 3, by location of the selected position in the first input field area or in the second input field area, and the degree determination part 351b, namely, the numerical value “30” in the example of FIG. 3, by internal location of the selected position within the first input field area or within the second input field area, respectively.

The selection part of the single input element being defined by location of the selected position, such as that selected by the slider in the example if FIG. 3, “in the first input field area or in the second input field area” refers to defining the selection part on the basis of whether the selected position lies in the first input field area or in the second input field area.

The “internal location” of the selected position within the first or the second input field area refers to where, within said first or second input field area, the selected location lies. For example, internal location close to the midpoint 344 of the scale 340, either within the first or the second input field area or the negative or positive part, respectively, of the scale relates to low numerical values and thus low degree of the color enhancement effect to be applied. On the other hand, moving the slider father away from the midpoint constitutes defining a higher degree of the selected color enhancement effect.

The apparatus 300 of FIG. 3 constitutes an example of an apparatus comprising a display, and processing unit which is configured to control the display to show thereon a digital image, namely, the initial digital image, and graphical user interface comprising a slider movable by a user of the apparatus on a scale representing numerical values from a negative limit value to a positive limit value, the position of the slider on the scale defining a selection of a numerical value between the negative and positive limit values. The processing unit of such apparatus is further configured to obtain a color enhancement command comprising a selected numerical value defined by the user by positioning the slider; determine, in accordance with sign of the selected numerical value, selection between color enhancement effects of color boost and color pop; determine, in accordance with absolute value of the selected numerical value, degree of color enhancement effect; and apply a color enhancement effect to the digital image in accordance with the determined selection between color boost and color pop, and the determined degree of color enhancement effect.

In other embodiments, processing units of apparatuses may be configured to control displays to show thereon any other appropriate types of single graphical input tools with a first input field area and a second input field area.

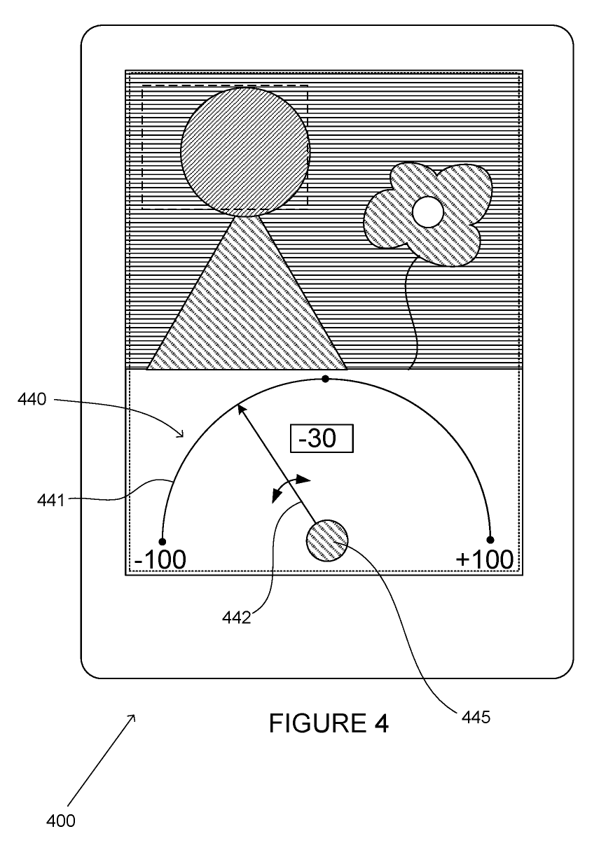

As one example, the apparatus 400 of FIG. 4 differs from that of FIG. 3 at least in that instead of a straight bar indicating a scale, the single graphical input tool 440 comprises a scale 441 illustrated as a curved line, and a rotating arm 442 rotatable by the user to select a position on the scale. A color indicator 445, located at the root of the arm, is shown in the graphical user interface to indicate the selected color.

In the above examples, the selected color may be selected in any appropriate way, automatically or inputted by the user.

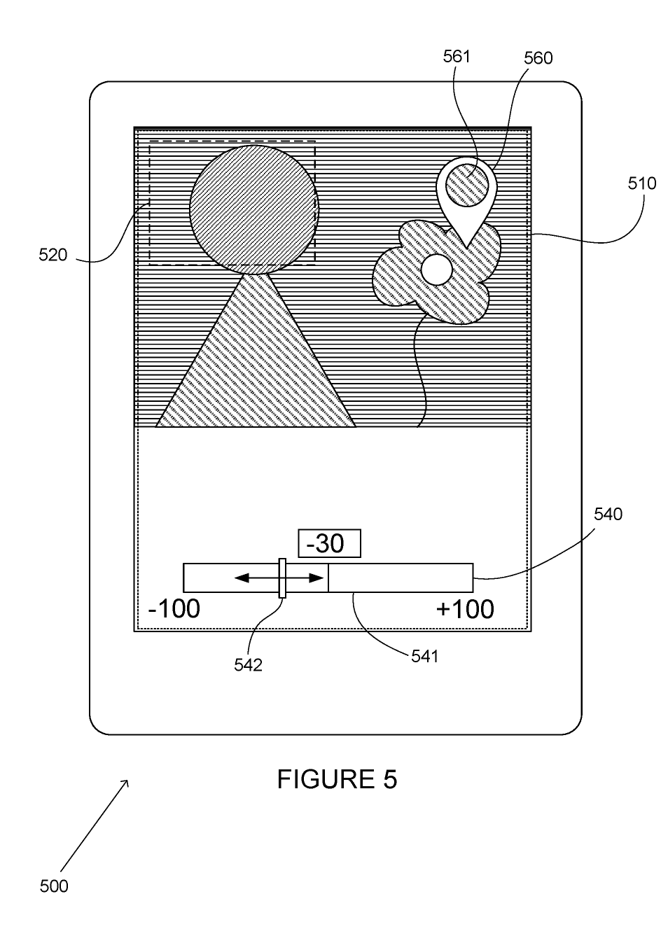

In the example of FIG. 5, the apparatus 500 may be generally in accordance with that of FIG. 3. The processing unit 520 is configured to control the display 510 to show, in addition to the single graphical user input tool 540, also a pointer 560 movable by the user along the initial digital image 531. The pointer 560 is an example of a graphical color selection tool via which the user may input a color selection command, illustrated on the display 510 as a colored field 561 within the pointer.

In other embodiments, any other appropriate types of graphical color selection tools may be used, such as color palettes or text input fields via which the user may input the color selection command as text.

The processing unit 520 is configured to obtain the color selection command input by the user via the graphical color selection tool, and to determine the selected color to be enhanced in accordance with the obtained color selection tool. Using the pointer, the user of the apparatus may thereby easily select a color present in the initial digital image to be the selected color. For example, when red is to be enhanced, the pointer may be positioned to a location where the image color is red. Thus, in the example of FIG. 5, the processing unit 520 is configured to determine the selected color in accordance with color of the initial digital image at the location of the pointer on the initial digital image.

In the example of FIG. 5, the pointer 560 of the graphical color selection tool and the single graphical user input tool with the scale 541 and the slider 542 are shown simultaneously. In other embodiments, it is possible to have the processing unit configured to control the display to show the graphical color selection tool before showing the single graphical user input tool, and to show the single graphical user input tool in response to obtaining the color selection command. Showing the single graphical user input tool only after obtaining the color selection command may enable larger portion of the operable display area to be used for showing the actual digital images.

In the examples of FIGS. 1 to 5, the display is part of the apparatus. In other embodiments, apparatuses may be implemented where a processing unit is configured to control an external display which is not part of the apparatus.

Being “configured to” perform the above operations when in use refers to the capability of and suitability of a processing unit for such operations. This may be achieved in various ways. For example, the processing unit may comprise at least one processor and at least one memory coupled to the at least one processor, the memory storing program code instructions which, when executed on the at least one processor, cause the processor to perform the action(s) at issue. Alternatively, or in addition, the functionally described features can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The processing unit may be a dedicated unit or sub-unit of a larger unit or module, specifically designed for the above operations. Alternatively, it may be a general purpose unit or sub-unit of the apparatus, also configured to operate other operations and actions.

In any of the examples and embodiments discussed above with reference to FIGS. 1 to 5, in controlling the display to show thereon specific content, such as the initial digital image, the single graphical user input tool, and/or the graphical color selection tool, the processing unit of an apparatus may control the display directly, or indirectly by controlling a separate display control unit or display controller, which in turn carries out the actual display control operations.

An action or operation being carried out “on the basis of” one or more factors refer to those factors being taken into account in that action or operation in such a way that the outcome of the action or operation depends on those factors, those factors thereby affecting the way of carrying out the action or operation.

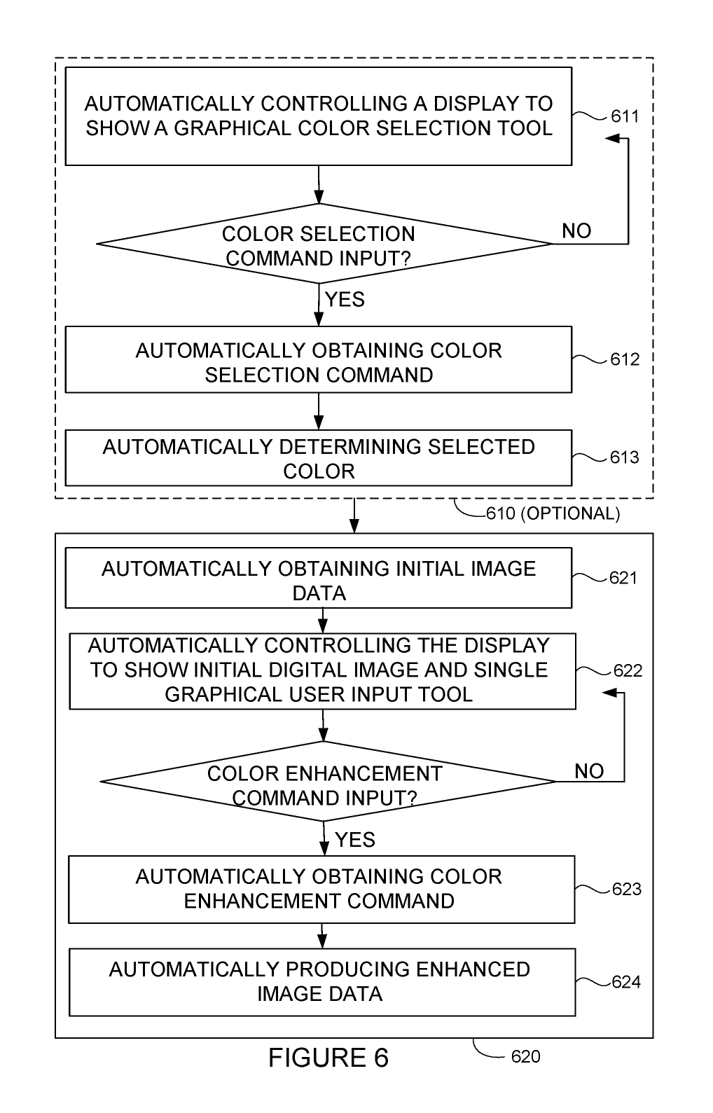

The operations which the processing units of the apparatuses discussed above with reference to FIGS. 1 to 5 are configured to carry out constitute operations of example methods which may be carried out also by other apparatuses of any appropriate types. The methods discussed below with reference to FIG. 6 may be carried out by apparatuses generally in accordance with any of those discussed above with reference to FIGS. 1 to 5. Those apparatuses, in turn, may operate generally in accordance with any of the methods discussed below with reference to FIG. 6.

The definitions and advantages discussed above with reference to FIGS. 1 to 5 apply, mutatis mutandis, also to the methods discussed below with reference to FIG. 6. The same applies vice versa.

Any of the methods discussed above or below may be a computer-implemented method, i.e. a method carried out by a computer or at least one processor and, when appropriate, any appropriate equipment, such as suitable digital image sensor, connected to the computer or the at least one processor.

The method of FIG. 6 which may be a computer implemented method starts, in optional first group of operations 610, by automatically controlling, in operation 611, a display to show thereon a graphical color selection tool allowing the user of the apparatus to input, via the graphical color selection tool, a color selection command defining a color to be enhanced in the enhanced image data in comparison to the initial image data. The color selection tool may be in accordance with any of those examples discussed above with reference to FIG. 5.

Once a color selection command, input by the user via the graphical color selection tool, is observed, it is automatically obtained in operation 612. In operation 613, selected color is automatically determined in accordance with the obtained color selection command.

In other embodiments, instead of operations in accordance with the optional first group of operations 610, a selected color may be automatically determined or obtained by any other appropriate way.

In second group of operations 620, the actual color enhancement effect is applied. In operation 621, initial image data of an initial digital image frame is automatically obtained. In step 622, the display is automatically controlled to show thereon an initial digital image in accordance with the initial image data, and a single graphical user input tool allowing a user of the apparatus to input, via the single graphical user input tool, a color enhancement command for enhancing a selected color in the initial digital image, which color enhancement command defines selection between color enhancement effects of color boost and color pop, i.e. between increasing colorfulness of the selected color or decreasing colorfulness of other color(s), and degree of the selected color enhancement effect.

Once a color enhancement command, input by the user via the graphical color selection tool, is observed, it is automatically obtained in operation 623. In operation 624, enhanced image data is automatically produced, which enhanced image data is enhanced, for the selected color, in accordance with the obtained color enhancement command.

The enhanced image data may be produced by modifying the initial image data. Alternatively, a new image data entity may be generated.

The enhance image data may be used to provide an enhanced digital image frame which may be appropriately stored or transmitted in or to any appropriate apparatus or location.

“Controlling” a display to show thereon some display content may refer to generating or providing instructions, implemented in any appropriate form such as various electrical control signals, which instructions, when appropriately executed on appropriate unit(s), module(s), or element(s) of an apparatus, causes the display, which may be part of the same apparatus, to show the display content thereon. Thus, “controlling” a display to show such content may refer to “causing” the display to show that content.

“Automatically” performing one or more operations refers to performing the operation(s) at issue by one or more appropriate data processing units or modules, such as the process units and display controllers discussed above with reference to FIGS. 1 to 5, according to specific rules and procedures, without need for any contribution provided or determination performed by a user of an apparatus or device incorporating such unit or module. In addition to those operations specifically stated to be performed automatically, also other operations may be carried completely or partially automatically.

Some embodiments are further discussed shortly in the following.

In a first aspect, an apparatus comprises a processing unit, the processing unit being configured to obtain initial image data of an initial digital image frame; control the display to show thereon an initial digital image in accordance with the initial image data, and a single graphical user input tool allowing a user of the apparatus to input, via the single graphical user input tool, a color enhancement command for enhancing a selected color in the initial digital image, the color enhancement command defining selection between color enhancement effects of increasing colorfulness of the selected color and decreasing colorfulness of one or more colors differing from the selected color, and degree of the selected color enhancement effect; obtain a color enhancement command input by the user via the single graphical user input tool; and produce enhanced image data enhanced, in comparison to the initial image data, for the selected color, in accordance with the obtained color enhancement command. The display may be a part of the apparatus, or an external display.

In an embodiment of the first aspect, the processing unit is configured to control the display to show the single graphical user input tool as allowing the user to input the color enhancement command as a single input element.

In an embodiment of the first aspect, in accordance with the previous embodiment, the single input element comprises a selection part and a degree determination part, the processing unit being configured to, for producing the enhanced image data, determine selection between increasing colorfulness of the selected color and decreasing colorfulness of one or more colors different from the selected color in accordance with the selection part, and degree of the selected color enhancement effect in accordance with the degree determination part.

In an embodiment of the first aspect, in accordance with the previous embodiment, the processing unit is configured to control the display to show the single graphical user input tool as comprising a text input field allowing the user to input the single input element as text.

In an embodiment of the first aspect, in accordance with the previous embodiment, the selection part comprises a sign, and the degree determination part comprises a number.

In an alternative embodiment of the first aspect, in accordance with the embodiment preceding the two previous embodiments, the processing unit is configured to control the display to show the single graphical user input tool as comprising an input field having a first input field area and a second input field area, allowing the user to input the single input element by selecting a position within the input field, the selection part of the single input element being defined by location of the selected position in the first input field area or in the second input field area, and the degree determination part being defined by internal location of the selected position within the first input field area or within the second input field area, respectively.

In an embodiment of the first aspect, in accordance with the previous embodiment, the input field comprises a scale and the processing unit is configured to control the display to show the single graphical user input tool as comprising a sliding pointer slidable by the user along the scale.

In an alternative embodiment of the first aspect, in accordance with the embodiment preceding the previous embodiment, the input field comprises a scale and the processing unit is configured to control the display to show the single graphical user input tool as comprising a rotating arm rotatable by the user to select a position on the scale.

In an embodiment of the first aspect, which may be in accordance with any of the preceding embodiments of the first aspect, the processing unit is further configured to control the display to show thereon a graphical color selection tool allowing the user of the apparatus to input, via the graphical color selection tool, a color selection command defining a color to be enhanced in the enhanced image data in comparison to the initial image data; obtain a color selection command input by the user via the graphical color selection tool; and determine, for producing the enhanced image data, the selected color in accordance with the obtained color selection command.

In an embodiment of the first aspect, in accordance with the previous embodiment, the graphical color selection tool comprises a pointer movable by the user along the initial digital image, the processing unit being configured to determine the selected color in accordance with color of the initial digital image at location of the pointer thereon.

In an embodiment of the first aspect, in accordance with any of the two previous embodiments, the processing unit is configured to control the display to show the graphical color selection tool before showing the single graphical user input tool, and to show the single graphical user input tool in response to obtaining the color selection command.

In an embodiment of the first aspect, which may be in accordance with any of the preceding embodiments of the first aspect, the apparatus is implemented as a personal computer, a laptop computer, a table computer, a smart phone, a mobile phone, or a digital image viewing apparatus.

In a second aspect, an apparatus comprises a display, and a processing unit, the processing unit being configured to control the display to show thereon a digital image, and graphical user interface comprising a slider movable by a user of the apparatus on a scale representing numerical values from a negative limit value to a positive limit value, the position of the slider on the scale defining a selection of a numerical value between the negative and positive limit values; obtain a color enhancement command comprising a selected numerical value defined by the user by positioning the slider; determine, in accordance with a sign of the selected numerical value, selection between color enhancement effects of increasing colorfulness of a selected color and decreasing colorfulness of one or more colors different from the selected color; determine, in accordance with an absolute value of the selected numerical value, degree of color enhancement effect; and apply a color enhancement effect to the digital image in accordance with the determined selection between increasing colorfulness of the selected color and decreasing colorfulness of one or more colors different from the selected color, and the determined degree of color enhancement effect.

The “sign” and the “absolute value” refer to the mathematical sign and the mathematical absolute value, respectively, of the selected numerical value. Sign, or mathematical sign, refers to the property of the selected value determining whether the selected value is negative or positive. Absolute value, or mathematical absolute value, refers to the property of the selected value determining the magnitude of the selected value.

In a third aspect, a method comprises automatically obtaining initial image data of an initial digital image frame; automatically controlling a display to show thereon an initial digital image in accordance with the initial image data, and a single graphical user input tool allowing a user of the apparatus to input, via the single graphical user input tool, a color enhancement command for enhancing a selected color in the initial digital image, the color enhancement command defining selection between color enhancement effects of increasing colorfulness of the selected color and decreasing colorfulness of one or more colors different from the selected color, and degree of the selected color enhancement effect; automatically obtaining a color enhancement command input by the user via the single graphical user input tool; and automatically produce enhanced image data enhanced, in comparison to the initial image data, for the selected color, in accordance with the obtained color enhancement command.

The method may be a computer implemented method, “computer implemented” referring to a method, the operations of which may be carried out by one or more processors of any appropriate type.

In an embodiment of the third aspect, the display is automatically controlled to show the single graphical user input tool as allowing the user to input the color enhancement command as a single input element.

In an embodiment of the third aspect, in accordance with the previous embodiment, the single input element comprises a selection part and a degree determination part, the method comprising, for producing the enhanced image data, determining selection between increasing colorfulness of the selected color and decreasing colorfulness of one or more colors different from the selected color in accordance with the selection part, and degree of the selected color enhancement effect in accordance with the degree determination part.

In an embodiment of the third aspect, in accordance with the previous embodiment, the display is automatically controlled to show the single graphical user input tool as comprising a text input field allowing the user to input the single input element as text.

In an embodiment of the third aspect, in accordance with the previous embodiment, the selection part comprises a sign, and the degree determination part comprises a number.

In an alternative embodiment of the third aspect, in accordance with the embodiment preceding the two previous embodiments, the display is controlled to show the single graphical user input tool as comprising an input field having a first input field area and a second input field area, allowing the user to input the single input element by selecting a position within the input field, the selection part of the single input element being defined by location of the selected position in the input field area or in the second input field area, and the degree determination part being defined by internal location of the selected position within the input field area or within the second input field area, respectively.

In an embodiment of the third aspect, in accordance with the previous embodiment, the input field comprises a scale, and the display is automatically controlled to show the graphical user input tool as comprising a sliding pointer slidable by the user along the scale.

In an alternative embodiment of the third aspect, in accordance with the embodiment preceding the previous embodiment, the input field comprises a scale, and the display is automatically controlled to show the graphical user input tool as comprising a rotating arm rotatable by the user to select a position on the scale.

In an embodiment of the third aspect, which may be in accordance with any of the previous embodiments, the method further comprises automatically controlling the display to show thereon a graphical color selection tool allowing the user of the apparatus to input, via the graphical color selection tool, a color selection command defining a color to be enhanced in the enhanced image data in comparison to the initial image data; automatically obtaining a color selection command input by the user via the graphical color selection tool; and automatically determining, for producing the enhanced image data, the selected color in accordance with the obtained color selection command.

In an embodiment of the third aspect, in accordance with the previous embodiment, the graphical color selection tool comprises a pointer movable by the user along the digital image, the method comprising automatically determining the selected color in accordance with color of the initial digital image at location of the pointer thereon.

In an embodiment of the third aspect, which may be in accordance with any of the two previous embodiments, the display is automatically controlled to show the graphical color selection tool before showing the single graphical user input tool, and to show the single graphical user input tool in response to obtaining the color selection command.

The embodiments illustrated and described herein as well as embodiments not specifically described herein but within the scope of aspects of the claims constitute example means for providing an apparatus for image editing, such apparatus comprising an interactive user interface allowing a user to initiate image enhancing operations by inputting color enhancement commands to the apparatus. For example, a processing unit, when configured to obtain initial image data, control a display to show thereon an initial digital image and a single graphical user input tool, obtain a color enhancement command, and produce enhanced image data enhanced in accordance with the obtained color enhancement tool, constitute example means for obtaining initial image data, controlling a display to show thereon an initial digital image and a single graphical user input tool, obtaining a color enhancement command, and producing enhanced image data enhanced in accordance with the obtained color enhancement tool. A display thereby controlled by such processing unit constitutes example means for displaying an initial digital image and a single graphical user input tool. Further, such single graphical user input tool constitutes example means for allowing a user to input a color enhancement command.

Although some of the present embodiments may be described and illustrated as being implemented in a smartphone, a mobile phone, a tablet computer, or a personal computer, these are only examples of an apparatus and not a limitation. As those skilled in the art will appreciate, the present embodiments are also suitable for application in a variety of different other types of devices and apparatuses, such as portable and portable devices, for example, in lap top computers, game consoles or game controllers, various wearable devices, etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

1. An apparatus comprising
a processing unit configured to
obtain initial image data of an initial digital image frame;
control a display to show thereon an initial digital image in accordance with the initial image data, and a single graphical user input tool allowing a user of the apparatus to input, via the single graphical user input tool, a color enhancement command for enhancing a selected color in the initial digital image, the color enhancement command defining selection between color enhancement effects of increasing colorfulness of the selected color and decreasing colorfulness of one or more colors differing from the selected color, and degree of the selected color enhancement effect;
obtain a color enhancement command input by the user via the single graphical user input tool; and
produce enhanced image data enhanced, in comparison to the initial image data, for the selected color, in accordance with the obtained color enhancement command.

2. An apparatus as defined in claim 1, wherein the processing unit is configured to control the display to show the single graphical user input tool as allowing the user to input the color enhancement command as a single input element.

3. An apparatus as defined in claim 2, wherein the single input element comprises a selection part and a degree determination part, the processing unit being configured to, for producing the enhanced image data, determine selection between increasing colorfulness of the selected color and decreasing colorfulness of one or more colors different from the selected color in accordance with the selection part, and degree of the selected color enhancement effect in accordance with the degree determination part.

4. An apparatus as defined in claim 3, wherein the processing unit is configured to control the display to show the single graphical user input tool as comprising a text input field allowing the user to input the single input element as text.

5. An apparatus as defined in claim 4, wherein the selection part comprises a sign, and the degree determination part comprises a number.

6. An apparatus as defined in claim 3, wherein the processing unit is configured to control the display to show the single graphical user input tool as comprising an input field having a first input field area and a second input field area, allowing the user to input the single input element by selecting a position within the input field, the selection part of the single input element being defined by location of the selected position in the first input field area or in the second input field area, and the degree determination part being defined by internal location of the selected position within the first input field area or within the second input field area, respectively.

7. An apparatus as defined in claim 6, wherein the input field comprises a scale and the processing unit is configured to control the display to show the single graphical user input tool as comprising a sliding pointer slidable by the user along the scale.

8. An apparatus as defined in claim 6, wherein the input field comprises a scale and the processing unit is configured to control the display to show the single graphical user input tool as comprising a rotating arm rotatable by the user to select a position on the scale.

9. An apparatus as defined in claim 1, wherein the processing unit is further configured to
control the display to show thereon a graphical color selection tool allowing the user of the apparatus to input, via the graphical color selection tool, a color selection command defining a color to be enhanced in the enhanced image data in comparison to the initial image data;
obtain a color selection command input by the user via the graphical color selection tool; and
determine, for producing the enhanced image data, the selected color in accordance with the obtained color selection command.

10. An apparatus as defined in claim 9, wherein the graphical color selection tool comprises a pointer movable by the user along the initial digital image, the processing unit being configured to determine the selected color in accordance with color of the initial digital image at location of the pointer thereon.

11. An apparatus as defined in claim 9, wherein the processing unit is configured to control the display to show the graphical color selection tool before showing the single graphical user input tool, and to show the single graphical user input tool in response to obtaining the color selection command.

12. An apparatus comprising
a display; and
a processing unit configured to
control the display to show thereon a digital image, and graphical user interface comprising a slider movable by a user of the apparatus on a scale representing numerical values from a negative limit value to a positive limit value, the position of the slider on the scale defining a selection of a numerical value between the negative and positive limit values;
obtain a color enhancement command comprising a selected numerical value defined by the user by positioning the slider;
determine, in accordance with a sign of the selected numerical value, selection between color enhancement effects of increasing colorfulness of a selected color and decreasing colorfulness of one or more colors different from the selected color;
determine, in accordance with an absolute value of the selected numerical value, degree of color enhancement effect; and
apply a color enhancement effect to the digital image in accordance with the determined selection between increasing colorfulness of the selected color and decreasing colorfulness of one or more colors different from the selected color, and the determined degree of color enhancement effect.

13. A method comprising
automatically obtaining initial image data of an initial digital image frame;
automatically controlling a display to show thereon an initial digital image in accordance with the initial image data, and a single graphical user input tool allowing a user of the apparatus to input, via the single graphical user input tool, a color enhancement command for enhancing a selected color in the initial digital image, the color enhancement command defining selection between color enhancement effects of increasing colorfulness of the selected color and decreasing colorfulness of one or more colors different from the selected color, and degree of the selected color enhancement effect;
automatically obtaining a color enhancement command input by the user via the single graphical user input tool; and
automatically producing enhanced image data enhanced, in comparison to the initial image data, for the selected color, in accordance with the obtained color enhancement command.

14. A method as defined in claim 13, wherein the display is automatically controlled to show the single graphical user input tool as allowing the user to input the color enhancement command as a single input element.

15. A method as defined in claim 14, wherein the single input element comprises a selection part and a degree determination part, the method comprising, for producing the enhanced image data, determining selection between increasing colorfulness of the selected color and decreasing colorfulness of one or more colors different from the selected color in accordance with the selection part, and degree of the selected color enhancement effect in accordance with the degree determination part.

16. A method as defined in claim 15, wherein the display is automatically controlled to show the single graphical user input tool as comprising a text input field allowing the user to input the single input element as text.

17. A method as defined in claim 16, wherein the selection part comprises a sign, and the degree determination part comprises a number.

18. A method as defined in claim 15, wherein the display is controlled to show the single graphical user input tool as comprising an input field having a first input field area and a second input field area, allowing the user to input the single input element by selecting a position within the input field, the selection part of the single input element being defined by location of the selected position in the input field area or in the second input field area, and the degree determination part being defined by internal location of the selected position within the input field area or within the second input field area, respectively.

19. A method as defined in claim 18, wherein the input field comprises a scale, and the display is automatically controlled to show the graphical user input tool as comprising a sliding pointer slidable by the user along the scale.

20. A method as defined in claim 13, wherein the method further comprises
automatically controlling the display to show thereon a graphical color selection tool allowing the user of the apparatus to input, via the graphical color selection tool, a color selection command defining a color to be enhanced in the enhanced image data in comparison to the initial image data;
automatically obtaining a color selection command input by the user via the graphical color selection tool; and
automatically determining, for producing the enhanced image data, the selected color in accordance with the obtained color selection command.
